(19) United States
(12) Patent Application Publication
(10) Pub. No.: US 2024/0095050 A1
(43) Pub. Date: Mar. 21, 2024

(54) INFORMATION PROCESSING APPARATUS AND CONTROL METHOD THEREFOR

(71) Applicant: CANON KABUSHIKI KAISHA, Tokyo (JP)

(72) Inventor: NAOKI SHINOZUKA, Kanagawa (JP)

(21) Appl. No.: 18/466,666

(22) Filed: Sep. 13, 2023

(30) Foreign Application Priority Data
Sep. 16, 2022 (JP) 2022-148631

(51) Int. Cl. G06F 9/451; G06F 3/14

(52) U.S. Cl. CPC G06F 9/452; G06F 3/14

(57) ABSTRACT

An information processing apparatus includes a display unit configured to display a plurality of windows in an overlapping manner, the plurality of windows including a first window for a first application and a second window for a second application to be started by the first application. The second application transmits, to the first application, a notification indicating that the second window has been displayed, and the first application performs display control to hide the first window in a case where the notification is received.

### BACKGROUND

### Field

The present disclosure relates to an information processing apparatus and a method for controlling the information processing apparatus.

### Description of the Related Art

A technique for displaying a plurality of windows on a display device connected to an information processing apparatus is discussed. Japanese Patent Application Laid-Open No. 2011-96132 discusses a window display control technique for preventing a user operation from being disturbed during display of a plurality of windows on a display device.

In some cases, when a new application is started, a window for the application is not displayed in the foreground and is displayed behind another window, which makes it difficult for a user to check if the application is started.

### SUMMARY

In view of the above-described circumstances, the present disclosure is directed to improving a user's convenience in an information processing apparatus including a display unit on which a plurality of windows is displayed in an overlapping manner.

According to an aspect of the present disclosure, an information processing apparatus includes a display unit configured to display a plurality of windows in an overlapping manner, the plurality of windows including a first window for a first application and a second window for a second application to be started by the first application. The second application transmits, to the first application, a notification indicating that the second window has been displayed, and the first application performs display control to hide the first window in a case where the notification is received.

Further features of the present disclosure will become apparent from the following description of exemplary embodiments with reference to the attached drawings.

### BRIEF DESCRIPTION OF THE DRAWINGS

FIG. 1 is a block diagram illustrating a system configuration according to an exemplary embodiment of the present disclosure.

FIG. 2 is a flowchart illustrating window display processing according to the exemplary embodiment.

FIGS. 3A to 3E each illustrate a window display state (without any other window) according to the exemplary embodiment.

FIGS. 4A and 4B each illustrate an example of a screen to be displayed when a Universal Windows® Platform (UWP) application is in an input reception state.

FIGS. 5A to 5E each illustrate a window display state (with another window) according to the exemplary embodiment.

FIGS. 6A to 6C each illustrate a window display state (another window is active) according to the exemplary embodiment.

FIG. 7 is a block diagram illustrating a system configuration according to another exemplary embodiment.

FIG. 8 is a flowchart illustrating window display processing according to the other exemplary embodiment.

### DESCRIPTION OF THE EMBODIMENTS

Exemplary embodiments of the present disclosure will be described in detail below with reference to the accompanying drawings. The following exemplary embodiments are not meant to limit the scope of the present disclosure as encompassed by the claims, and not all combinations of features described in the exemplary embodiments are essential to the solution of the disclosure. In the following exemplary embodiments, a personal computer (PC) is described as an example of an information processing apparatus according to an exemplary embodiment of the present disclosure, but instead a tablet terminal and the like may also be used.

The present exemplary embodiment assumes a case where a desktop application is started using a configuration called Desktop Bridge from a Universal Windows® Platform (UWP) application supported by Windows® 10.

The Desktop Bridge is a configuration for starting a desktop application from a UWP application. In the Desktop Bridge, the desktop application to be started is first registered in the manifest of the UWP application and the desktop application to be started is included in a dedicated package prepared for each UWP application. Use of a dedicated application programming interface (API) enables the UWP application to start the registered desktop application from the UWP application.

Desktop applications will now be described. Desktop applications are executed or installed using an executable file (.exe file, etc.) provided by each vendor, which is a typical mechanism, and have the merit of achieving functions that cannot be achieved by UWP applications. For this reason, in the case of implementing a UWP application, employment of a method of starting a desktop application from the UWP application and causing the desktop application to implement some of the functions has been studied. However, UWP applications are a new type of applications that are installed only from a dedicated site called Windows® Store. Further, UWP applications are protected with a high level of security, and thus are allowed to access only the package including the UWP application. Therefore, each UWP application cannot access an external desktop application, which makes it impossible to start the desktop application in a standard manner.

To solve this issue, the configuration called Desktop Bridge as described above is prepared. However, the Desktop Bridge configuration also has limitations that, for example, only one desktop application can be started. Accordingly, the Desktop Bridge is generally configured to start a launcher application as a desktop application and start, from the launcher application, a desktop application including a main function different from the main function of the launcher application.

As described above, in general, when a display area of an existing window overlaps a display area of a newly displayed window, an operating system (OS) controls the newly displayed window to be displayed on top of the existing window. However, in the case of using the Desktop Bridge configuration, each window to be displayed via a desktop application started by a UWP application may be displayed in an active state or may be displayed in an inactive state based on the limitations of the OS. If a window to be displayed via a desktop application is displayed in the inactive state, a window for executing subsequent processing is displayed behind the window that is unnecessary in the subsequent processing, which may lead to a decrease in user's convenience. In view of this, according to the present exemplary embodiment, in a case where the UWP application that has displayed a window starts a desktop application using the Desktop Bridge configuration and the desktop application displays a new window, a display state of an unnecessary window for the UWP application is changed to a non-display state. If the display state of the window for the UWP application is changed to the non-display state in a state where inactive windows other than the window for the UWP application are present on the display device, the topmost displayed window among the inactive windows becomes an active window. In such a case, if the desktop application is started in the inactive state, the window for the desktop application can be displayed behind the window that has newly become an active window. For this reason, the UWP application receives a notification indicating that display of the window for the desktop application is completed from the desktop application. When it is confirmed that the notification is received, the display state of the window for the UWP application is changed to the non-display state. Thus, even when the window for the desktop application is displayed in the inactive state, the window for the desktop application is displayed behind the window for the UWP application. After that, the display state of the window for the UWP application is changed to the non-display state, thus allowing the window for the desktop application to be displayed on top of all the windows. The present exemplary embodiment will be described in detail below.

Exemplary embodiments of the present disclosure will be described in detail below by way of example with reference to the accompanying drawings. However, components described in the exemplary embodiments are merely examples, and the scope of the disclosure is not limited only to the components.

### System Configuration

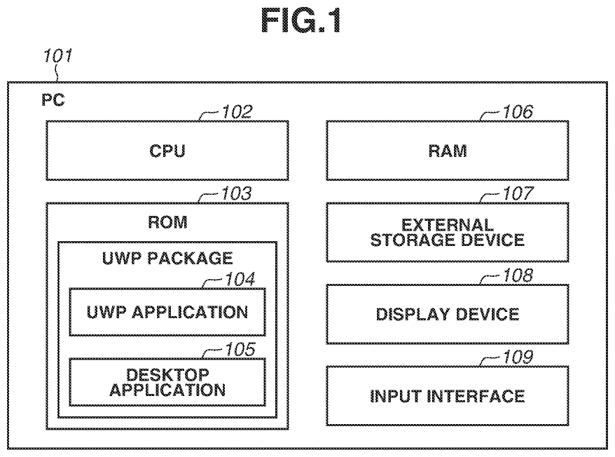

A system configuration according to a first exemplary embodiment will be described with reference to FIG. 1. A PC 101 includes a central processing unit (CPU) 102, a read-only memory (ROM) 103, a random access memory (RAM) 106, an external storage device 107, a display device 108, and an input interface 109.

The ROM 103 stores a UWP application 104, a desktop application 105 to be started from the UWP application 104 using the Desktop Bridge, and other applications (e.g., an explorer and a browser). The UWP application 104 and the desktop application 105 are included in the same UWP package, and only the desktop application 105 is able to be started from the UWP application 104 using Desktop Bridge.

The external storage device 107 stores an OS and various other data. The CPU 102 reads out the UWP application 104 and the desktop application 105 from the ROM 103 into the RAM 106 and executes the UWP application 104 and the desktop application 105 to thereby execute processing programmed in the UWP application 104 and the desktop application 105. During this time, the UWP application 104 and the desktop application 105 display a graphical user interface (GUI) included in each of the UWP application 104 and the desktop application 105 as a window on the display device 108.

Windows to be displayed on the display device 108 are controlled by the OS. In a case where a window is displayed in an active state, the window is displayed on top of all the windows displayed on the display device 108. On the other hand, in a case where a window is displayed in an inactive state, the window is displayed immediately behind an active window, that is, displayed on top of all the inactive windows. When the UWP application 104 may start the desktop application 105, the window to be displayed may be started in the active state, or may be started in the inactive state. If the OS determines that the current active window is being operated by a user, the desktop application 105 is started with a newly displayed window in the inactive state.

The input interface 109 receives an input by the user and enables issuance of instructions for various data input and operations.

The PC 101 is generally configured to support multiple tasks and execute a plurality of applications at once. In the information processing apparatus, each started application is managed by the OS in units of processes. Each application including a GUI is able to display the GUI on the display device 108, such as a display. In this case, the GUI of each application is managed by the OS in units of windows. In general, when a plurality of applications each including a GUI is executed at once, a plurality of windows is simultaneously displayed on the display device 108. Such a system generally employs an overlapping format in which windows are displayed in an overlapping manner. In the overlapping format, a window state of a window that is displayed on top of all the windows and is ready to receive an input by the user is called an active state, and a window in the active state is called an active window. Windows other than the active window are called inactive windows. To bring an inactive window into the active state, for example, the user clicks the inactive window with a mouse. The window started in the inactive state is displayed behind an active window, more specifically, displayed on top of all the inactive windows.

The system that employs the overlapping format has a merit that the user can operate a certain window while checking another window. On the other hand, the system has a demerit that a newly displayed window is displayed on top of the existing window, which may disturb the user operation.

Assume a case where a first application (hereinafter referred to as a “startup application”) including a GUI starts a second application (hereinafter referred to as a “processing application”) including another GUI and the subsequent processing is performed by the processing application. In general, a window for a newly started application becomes an active window. For this reason, in a case where a display area of an existing window overlaps a display area of a newly displayed window, the OS controls the newly displayed window to be displayed on top of the existing window. Accordingly, a window for the startup application can be hidden behind the window for the processing application. However, the startup application is unnecessary in the subsequent processing, so that no problem arises.

Assume a case where a UWP application supported by Windows ° 10 is used as the startup application and a desktop application is started as the processing application. The window that the desktop application started by the UWP application displays may be displayed in the active state or may be displayed in the inactive state based on the limitations of the OS.

Initially, assume a case where the window for the desktop application is started in the inactive state and is displayed behind the window for the UWP application. In this case, the window for the desktop application for carrying out the subsequent processing is displayed behind the window for the UWP application that is unnecessary in the subsequent processing, which may lead to a decrease in user's convenience. If the entire area of the window for the desktop application is hidden behind the window for the UWP application, there is a possibility that the user cannot notice the start of the desktop application. It is difficult for the OS and with the window control technique discussed in the Japanese Patent Application Laid-Open No. 2011-96132 to flexibly change the control method depending on the specifications of each application, for example, such that the startup application starts the processing application and the subsequent processing is performed by the processing application. The present disclosure discusses a technique for solving this issue.

### Processing for UWP Application to Start Desktop Application

### 1. If No Other Window is Present

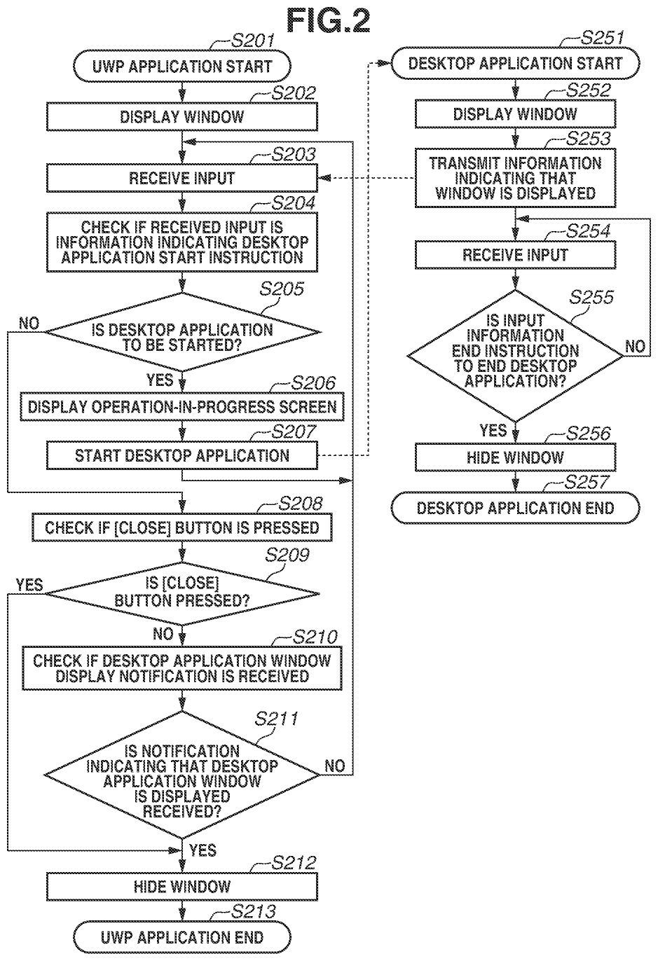

Next, a description will be provided of processing which is performed when the UWP application 104 starts the desktop application 105 in an environment where no windows other than the UWP application 104 and the desktop application 105 are present on the display device 108 according to the present exemplary embodiment, with reference to FIGS. 2 to 4B. In the present exemplary embodiment, assume that the UWP application 104 has a function of managing a printer and the desktop application 105 has a function of registering a printer. In other words, the UWP application 104 starts the desktop application 105 to register a printer. The function included in the UWP application 104 is not limited to the printer management function. It is sufficient for the UWP application 104 to have a function of starting the desktop application 105 using Desktop Bridge. Similarly, the function included in the desktop application 105 is not limited to the printer registration function.

a. Processing for UWP Application

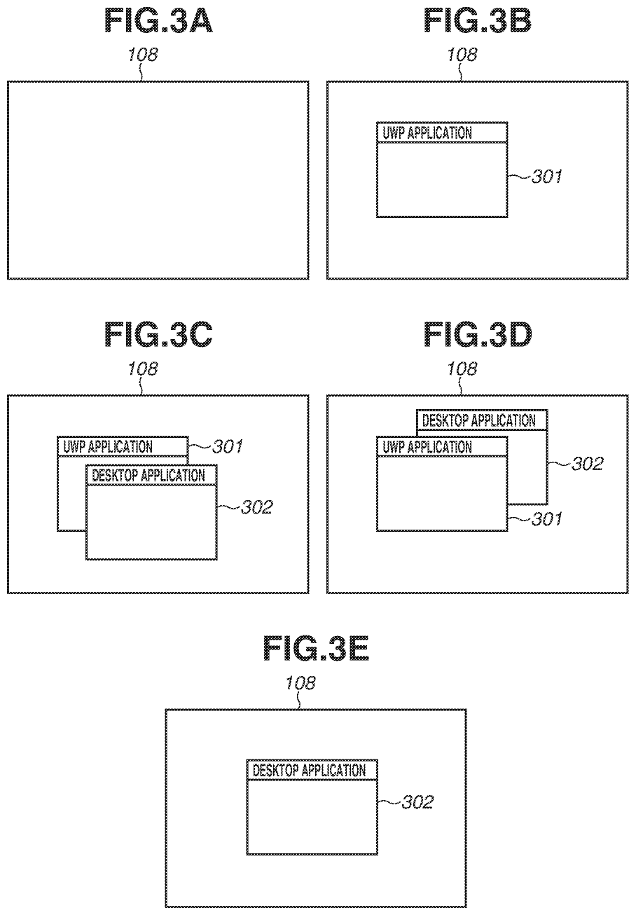

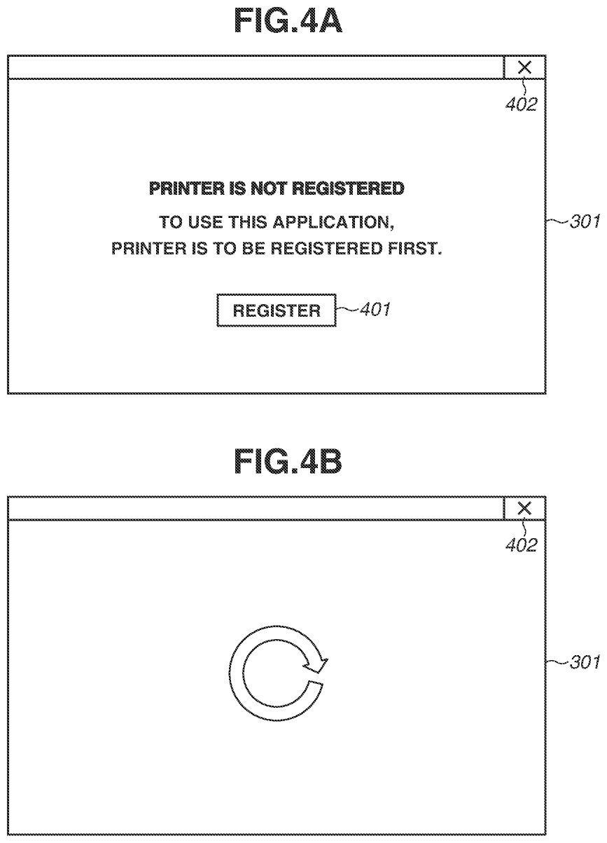

FIG. 2 is a flowchart illustrating an example of processing according to the present exemplary embodiment. FIGS. 3A to 3E each schematically illustrate a display state of the display device 108 according to the present exemplary embodiment. FIG. 3A illustrates a state where no window is displayed on the display device 108 before the processing illustrated in FIG. 2 is started. FIGS. 4A and 4B each illustrate an example of a display state of the UWP application 104 according to the present exemplary embodiment.

In step S201, the processing in the flowchart illustrated in FIG. 2 is started based on an event that the user starts and executes the UWP application 104 using the input interface 109 included in the PC 101.

For example, the UWP application 104 listed on a start menu is started by the user selecting the UWP application 104.

Next in step S202, the UWP application 104 displays a window for the UWP application 104 on the display device 108. In this case, only a window 301 for the UWP application 104 as illustrated in FIG. 3B is displayed on the display device 108.

Next in step S203, the UWP application 104 is in an input reception state after the window 301 is displayed. FIG. 4A illustrates an example of information to be displayed on the window 301 for the UWP application 104 which is in the input reception state. The window 301 for the UWP application 104 includes a [register] button 401 and a [close] button 402. The window 301 for the UWP application 104 may include buttons other than the [register] button 401 and the [close] button 402. When the user presses the [register] button 401, the UWP application 104 receives an input in step S203.

In step S204, the UWP application 104 checks if the received input is information indicating a desktop application start instruction.

Next in step S205, the UWP application 104 determines whether to start the desktop application, in other words, the UWP application 104 determines whether the received input is a desktop application start instruction.

If the UWP application 104 determines that the received input is the desktop application start instruction (YES in step S205), the processing proceeds to step S206.

In step S206, the UWP application 104 is in the process of starting the desktop application 105, and displays an operation-in-progress screen on the window 301. FIG. 4B illustrates an example of the screen indicating that the operation is in progress (operation-in-progress screen on which the progressing state is displayed) displayed on the window 301. While displaying the operation-in-progress screen, the UWP application 104 cannot accept an input corresponding to the [close] button 402.

Next in step S207, the UWP application 104 starts the desktop application 105 using the Desktop Bridge configuration. Then, the processing returns to step S203, and the UWP application 104 transitions to the input reception state again.

If the user presses a button other than the [register] button 401 in the input reception state in step S203, in step S205, the UWP application 104 determines that the received input is not the desktop application start instruction. If the UWP application 104 determines that the received input is not the desktop application start instruction (NO in step S205), the processing proceeds to step S208.

In step S208, the UWP application 104 checks if the [close] button 402 is pressed.

In step S209, the UWP application 104 determines whether the [close] button 402 is pressed. If the UWP application 104 determines that the [close] button 402 is pressed (YES in step S209), the processing proceeds to step S212.

In step S212, the UWP application 104 changes the display state of the window 301 to the non-display state.

In step S213, the UWP application 104 ends the processing of this flowchart. In the present exemplary embodiment, when the operation-in-progress screen is displayed in step S206, the UWP application 104 cannot accept an input corresponding to the [close] button 402. However, any other input may be used, as long as the input is to change the display state of the window 301 to the non-display state. Examples of the input for changing the display state of the window to the non-display state include a [minimize] button.

If the UWP application 104 receives an input other than pressing of the [close] button 402 in step S203, the processing proceeds to step S209. In step S209, if the UWP application 104 determines that the processing of the UWP application 104 is not ended (NO in step S209), the processing proceeds to step S210.

Next in step S210, the UWP application 104 checks if a notification indicating that a window 302 for the desktop application 105 has been displayed on the display device 108 is received. If the UWP application 104 has started the desktop application 105 using the Desktop Bridge configuration, the UWP application 104 cannot obtain a process handle or window handle for the desktop application 105.

As described above, this is caused due to the limitations of the OS since the UWP application 104 is protected with a high level of security. In other words, the UWP application 104 cannot recognize the startup state of the desktop application 105, the display state of the window 302, and the like. Thus, the UWP application 104 receives the notification from the desktop application 105, thus checking if the window 302 for the desktop application 105 has been displayed on the display device 108. The notification method will be described below in step S253.

Next in step S211, the UWP application 104 determines whether a notification indicating that the window 302 for the desktop application 105 has been displayed on the display device 108 is received. If it is determined that the notification indicating that the window 302 for the desktop application 105 has been displayed is not received (NO in step S211), the processing returns to step S203 and the UWP application 104 transitions to the input reception state again. If it is determined that the notification indicating that the window 302 for the desktop application 105 has been displayed on the display device 108 is received (YES in step S211), the processing proceeds to step S212.

Next in step S212, the display state of the window 301 is changed to the non-display state. In step S213, the UWP application 104 ends the processing of this flowchart.

b. Processing for Desktop Application

### (Screen Transition)

FIG. 3C or 3D illustrates a state at the timing when the UWP application 104 receives the notification from the desktop application 105 in step S211, that is, a state where the window 302 for the desktop application 105 is displayed on the display device 108.

FIG. 3C illustrates a case where the window 302 for the desktop application 105 is displayed in the active state on the window 301 for the UWP application 104.

In contrast, FIG. 3D illustrates a case where the window 302 for the desktop application 105 is displayed in the inactive state behind the window 301 for the UWP application 104.

FIG. 3E illustrates a state where the display state of the window 301 for the UWP application 104 is changed to the non-display state from the state illustrated in FIG. 3C or 3D, through the operation in step S212. The display state of the window 301 is changed to the non-display, so that the window 302 is displayed in the foreground in the display device 108, irrespective of whether the window 302 is started in the active state.

### (Desktop Application Processing)

Next, processing for the desktop application 105 to be started by the UWP application 104 using the Desktop Bridge configuration will be described. In step S207, the UWP application 104 starts the desktop application 105, thus starting the operation in step S251 and the operations in subsequent steps.

Initially in step S251, the desktop application 105 is started by the UWP application 104.

Next in step S252, the desktop application 105 displays the window 302 for the desktop application 105 on the display device 108. At this time, the display device 108 is in the display state illustrated in FIG. 3C or 3D as described above.

Next in step S253, the desktop application 105 starts the UWP application 104 through protocol activation, thus transmitting information (notification) indicating that the window 302 has been displayed on the display device 108 to the UWP application 104. The term “protocol activation” refers to a configuration for starting the corresponding program or application according to a designated protocol. Each UWP application is able to define any individual protocol. The term “protocol” refers to an arrangement for communication between computers. Examples of the protocol include HyperText Transfer Protocol (HTTP) for communication between a server and a client. The HTTP protocol is associated with a browser, such as Internet Explorer® or MicroSoft Edge®. When the HTTP protocol is designated in protocol activation, the browser can be started. In other words, an individual protocol is defined in advance in the UWP application 104 and the defined protocol is designated to thereby make it possible to start the UWP application 104 from the desktop application 105. In the protocol activation, a parameter can be designated together with the protocol. Thus, processing corresponding to a certain parameter is preliminarily defined in the UWP application 104, so that the UWP application 104 is enabled to execute the defined processing using a notification from the desktop application 105 as a trigger. More specifically, the desktop application 105 designates the parameter preliminarily defined in step S253 and starts the UWP application 104 through protocol activation. In step S203, the UWP application 104 receives the parameter designated by protocol activation. In step S211, it is determined that the window 302 for the desktop application 105 has been displayed.

After that, in step S212, processing of changing the display state of the window 301 to the non-display state is executed. In the present exemplary embodiment, the notification is issued from the desktop application 105 to the UWP application 104 through protocol activation. However, the notification method is not limited to this example. For example, the notification may be issued by establishing inter-process communication between the UWP application 104 and the desktop application 105 using a configuration called a pipe. In step S253, the desktop application 105 issues the notification indicating that the window 302 has been displayed, to the UWP application 104. Then, the processing proceeds to step S254.

In step S254, the desktop application 105 receives any input. In response to desktop application 105 receiving the input, the processing proceeds to step S255.

In step S255, the desktop application 105 determines whether the input information received in step S254 is an end instruction to end the desktop application 105. If the desktop application 105 determines that the received input is the end instruction to end the desktop application 105 (YES in step S255), the processing proceeds to step S256. If the desktop application 105 determines that the received input is not the end instruction to end the desktop application 105, in other words, determines that the processing is to be continued (NO in step S255), the processing returns to step S254 to transition to the input reception state.

In step S256, the desktop application 105 changes the display state of the window 302 to the non-display state.

In step S257, the desktop application 105 ends the processing of this flowchart.

In the present exemplary embodiment, any input can be received in step S254. However, the operation in step S254 is not limited to this example. For example, the desktop application 105 may automatically perform an operation without receiving any input, and at a timing when the operation is completed, the window 302 may transition to the non-display state to end the processing. According to the present exemplary embodiment, in step S211, if the UWP application 104 determines that the notification indicating that the window 302 for the desktop application 105 has been displayed on the display device 108 is received (YES in step S211), the processing proceeds to step S212. In step S212, the display state of the window 301 is changed to the non-display state. Then, in step S213, the processing is ended. Alternatively, after the operation in step S212, the processing may be returned to step S203 to cause the UWP application 104 to transition to the input reception state. In such a case, it is possible to start the UWP application 104 from the desktop application 105 through protocol activation and to display the window 302 again with a user operation, such as an operation to maximize the window. In the present exemplary embodiment, the input information is checked in the order of steps S204, S208, and S210, but the order of checking the input information is not limited to this order. The input information may be checked in any order.

2. Case where Another Window is Present

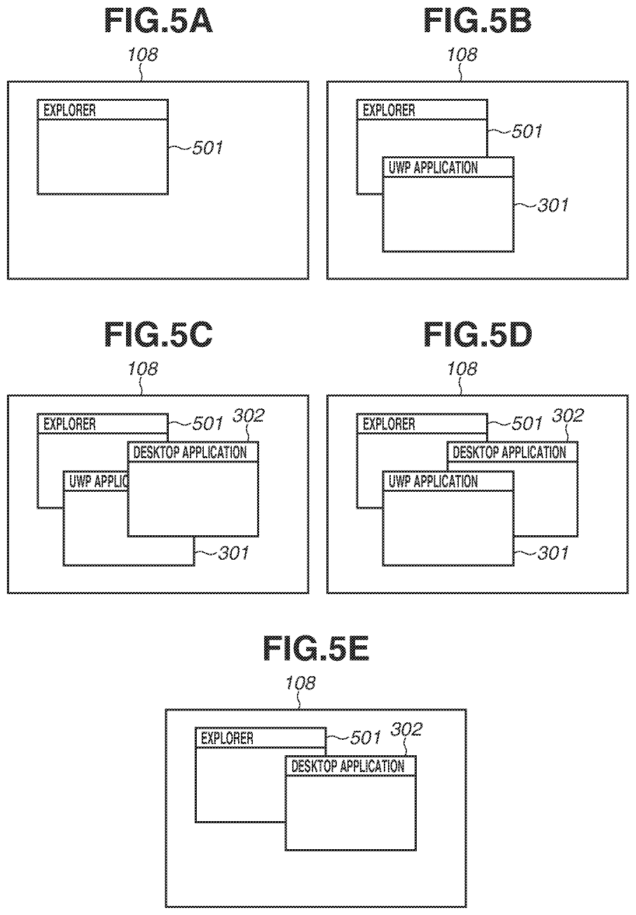

Next, a description will be provided of processing which is performed when the UWP application 104 starts the desktop application 105 in an environment where a window other than the UWP application 104 and the desktop application 105 is present on the display device 108 according to the present exemplary embodiment, with reference to FIGS. 2 and 5A to 5E.

### (Screen Transition)

FIGS. 5A to 5E each schematically illustrate a screen at each timing in an environment where a window 501 for an explorer, which is an example of a window other than the windows for the UWP application 104 and the desktop application 105, is displayed on the display device 108 according to the present exemplary embodiment. In the environment where the window 501 for the explorer is present, when the window 302 for the desktop application 105 is displayed in the inactive state using the Desktop Bridge configuration, the window 302 may be started behind the window 501. Even in such a case, according to the present exemplary embodiment, the window 302 for the desktop application 105 is able to be displayed in the foreground of the display device 108.

More specifically, FIG. 5A illustrates a state where the window 501 for the explorer is displayed on the display device 108 before the operations in step S201 and the subsequent steps are started.

FIG. 5B illustrates a state where the UWP application 104 displays the window 301 in step S202 from the state illustrated in FIG. 5A.

FIG. 5C or 5D illustrates a state where the UWP application 104 starts the desktop application 105 in step S207 from the state illustrated in FIG. 5B and the desktop application 105 displays the window 302 in step S252. FIG. 5C illustrates a case where the window 302 for the desktop application 105 is displayed in the active state and the window 302 for the desktop application 105 is superimposed on the window 301 for the UWP application 104. In contrast, FIG. 5D illustrates a case where the window 302 for the desktop application 105 is displayed in the inactive state and the window 302 for the desktop application 105 is hidden behind the window 301 for the UWP application 104. However, even when the window 302 for the desktop application 105 is started in the inactive state in the case illustrated in FIG. 5D, the window 302 is displayed on top of the window 501 for the explorer that is also an inactive window. In the subsequent operation in step S212, the display state of the window 301 for the UWP application 104 is changed to the non-display state.

In either case of FIG. 5C or FIG. 5D, a state where the window 302 for the desktop application 105 is displayed in the foreground of the display device 108 can be achieved as illustrated in FIG. 5E.

### 3. If Another Window is Active

Next, a description will be provided of a case where the display state of, for example, a window for the explorer other than the windows for the UWP application 104 and the desktop application 105 is changed to the active state while the UWP application 140 is starting the desktop application 105, with reference to FIGS. 2, 3A to 3E, and 6A to 6C.

More specifically, such a case indicates a case where, in step S203 illustrated in FIG. 2, after the user presses the [register] button 401, it takes a long time to start the desktop application 105 and the display state of the window 501 for the explorer is changed to the active state by a user operation on the input interface 109 before the desktop application 105 is started. This case will be described below.

In this case, the user is operating the window 501. Accordingly, it is desirable to maintain the active state of the window 501 even after the desktop application 105 displays the window 302.

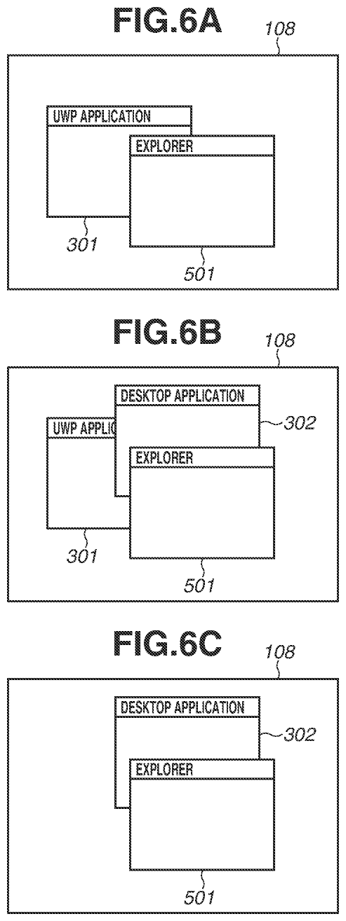

FIG. 6A illustrates a case where the window 501 for the explorer transitions to the active state from the state illustrated in FIG. 3B. In this state, if the desktop application 105 displays the window 302 in step S252, the OS determines that the window 501 for the explorer is being operated, and the window 302 is displayed behind the window 501 as illustrated in FIG. 6B. After that, in the operation in step S212, the UWP application 104 changes the display state of the window 301 to the non-display state. However, the active state of the window 501 for the explorer is maintained as illustrated in FIG. 6C, without any influence on the positional relationship between the window 302 and the window 501.

While the present exemplary embodiment illustrates an example where the display state of the window 501 for the explorer is changed to the active state in the environment as illustrated in FIG. 3B, the present exemplary embodiment is not limited to this case. For example, if it takes a long time for the UWP application 104 to start the desktop application 105, the window 501 for the explorer may be newly displayed by the input interface 109. In the present exemplary embodiment, the explorer is used as an example of an application to display a window other than the windows for the UWP application 104 and the desktop application 105. Alternatively, any other application may be used as long as the application is capable of displaying a window. While the present exemplary embodiment illustrates an example of the environment in which only one window 501 for the explorer is present as a window other than the windows for the UWP application 104 and the desktop application 105, the environment is not limited to this example. The present exemplary embodiment is applicable to an environment in which a plurality of windows is present.

In the exemplary embodiment described above, the UWP application 104 in the PC 101 starts the desktop application 105 using the Desktop Bridge configuration. In such a case, the exemplary embodiment described above enables the window 301 to be displayed in the foreground in the active state, irrespective of whether the window 301 for the desktop application 105 is started in the active state.

A second exemplary embodiment of the present disclosure will be described below. The first exemplary embodiment described above illustrates an example where one desktop application 105 is used, since there is a limitation that the number of desktop applications that is able to be started is one in the Desktop Bridge configuration.

The second exemplary embodiment illustrates an example where a launcher application is started as a desktop application via the Desktop Bridge configuration, and the desktop application including a main function different from the main function of the launcher application is started from the launcher application.

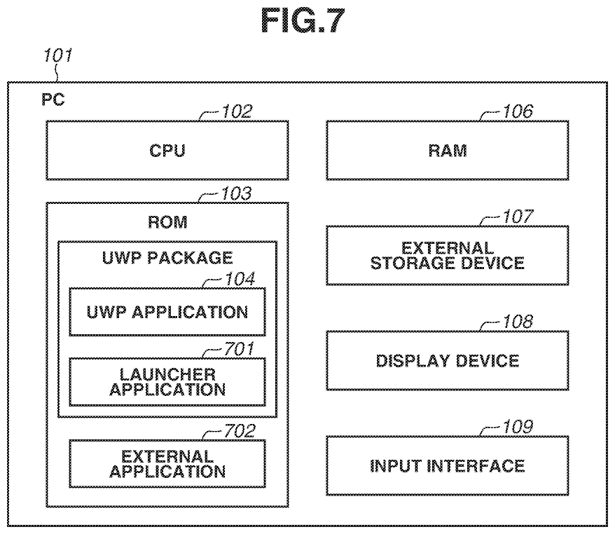

A system configuration according to the second exemplary embodiment will be described with reference to FIG. 7. As illustrated in FIG. 7, the ROM 103 in the PC 101 according to the second exemplary embodiment stores a launcher application 701 instead of the desktop application 105 in the system configuration according to the first exemplary embodiment illustrated in FIG. 1. The ROM 103 stores an external application 702 on the outside of the UWP package including the UWP application 104 and the launcher application 701. The launcher application 701 is a desktop application that is started from the UWP application 104 using the Desktop Bridge configuration, and the external application 702 is an application that is started from the launcher application 701. Thus, in the second exemplary embodiment, the UWP application 104 starts the launcher application 701 and the started launcher application 701 starts the external application 702. Here, the external application 702 is not limited only to a desktop application, but instead may be, for example, a UWP application.

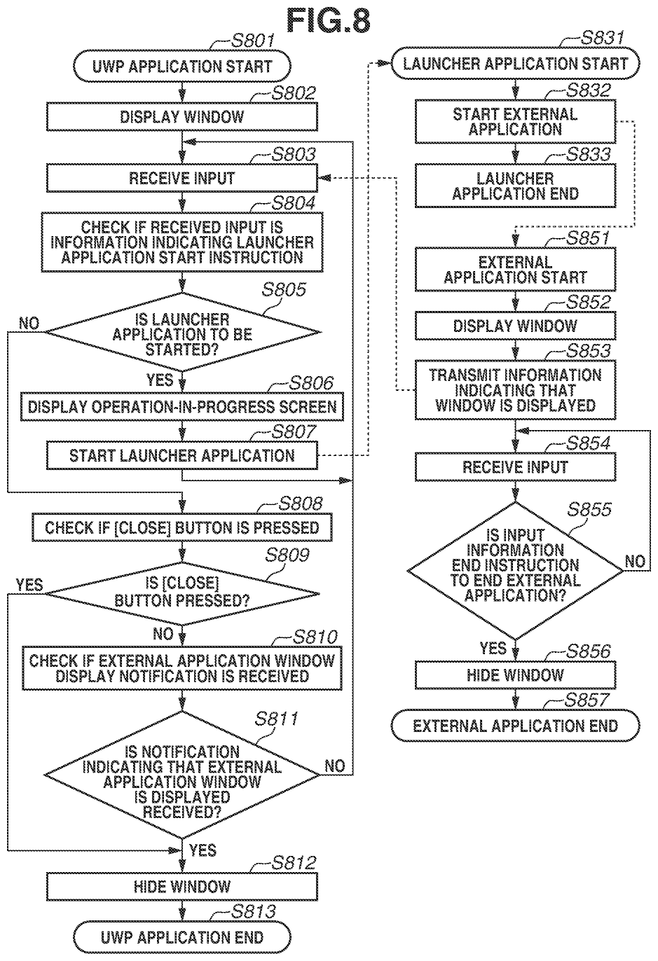

Next, processing which is performed when the UWP application 104 starts the launcher application 701 and the launcher application 701 starts the external application 702 will be described with reference to FIGS. 3A to 3E, 5A to 5E, and 8. The operations in steps S801 to S803, S806, S812, S813, S852 to S856 are similar to those in steps S201 to S203, S206, S212, S213, and S252 to S256, respectively, and thus descriptions thereof are omitted. The operations in steps S804, S805, and S807 correspond to those in steps S204, S205, and S207, respectively, in which the desktop application 105 is replaced by the launcher application 701. The operations in steps S810, S811, S851, and S857 correspond to those in steps S210, S211, S251, and S257, respectively, in which the desktop application 105 is replaced by the external application 702. In the following description, assume that the window 302 for the desktop application 105 illustrated in FIGS. 3A to 3E and FIGS. 5A to 5E is replaced by a window for the external application 702.

Processing for the launcher application 701 to be started by the UWP application 104 using the Desktop Bridge configuration will be described.

In step S807, the UWP application 104 starts the launcher application 701, thus starting the operations in step S831 and the subsequent steps.

In step S831, the launcher application 701 is started by the UWP application 104.

In step S832, the launcher application 701 starts the external application 702.

In step S833, the launcher application 701 ends the processing. In this case, the display device 108 is in the display state as illustrated in FIG. 3C, 3D, 5C, or 5D.

The external application 702 started in step S832 performs the operations in step S851 and subsequent steps, and the UWP application 104 performs the operations in step S803 and subsequent steps. As a result, the window 302 for the external application 702 is displayed in the foreground as an active window as illustrated in FIG. 3E or 5E. In the present exemplary embodiment, the external application 702 issues a notification indicating that the window 302 is displayed, to the UWP application 104 in step S853, but instead the launcher application 701 may issue the notification to the UWP application 104. At this time, if the external application 702 is a desktop application, the launcher application 701 is able to obtain a window handle, which makes it possible to recognize the display state of the window for the external application 702. Even in a case where the external application 702 is a UWP application, for example, the notification indicating whether the window 302 for the external application 702 is displayed is receivable by establishing inter-process communication between the launcher application 701 and the external application 702 using a configuration called a pipe. In the present exemplary embodiment, the launcher application 701 includes no GUI. However, the configuration of the launcher application 701 is not limited to this example. While only one external application 702 is started from the launcher application 701 in the present exemplary embodiment, the number of external applications 702 to be started is not limited to one. In a case where a plurality of windows for the launcher application 701 or the external application 702 is displayed, a notification indicating that display of the windows is completed is issued to the UWP application 104 at a timing when all the windows are displayed, thus enabling a desired window to be displayed in the foreground.

According to the second exemplary embodiment described above, similar advantageous effects as those in the first exemplary embodiment are obtainable also in a case where the UWP application 104 in the PC 101 starts the launcher application 701 using the Desktop Bridge configuration. Further, according to the second exemplary embodiment, the window for the external application 702 can be displayed in the foreground in the active state, irrespective of whether the window for the external application 702 is started in the active state.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2022-148631, filed Sep. 16, 2022, which is hereby incorporated by reference herein in its entirety.

What is claimed is:

1. An information processing apparatus comprising:
a display unit configured to display a plurality of windows in an overlapping manner, the plurality of windows including a first window for a first application and a second window for a second application to be started by the first application,
wherein the second application transmits, to the first application, a notification indicating that the second window has been displayed, and
wherein the first application performs display control to hide the first window in a case where the notification is received.

2. The information processing apparatus according to claim 1, wherein the first application includes a Universal Windows ° Platform application.

3. The information processing apparatus according to claim 2, wherein the first application starts the second application via Desktop Bridge.

4. The information processing apparatus according to claim 3, wherein the second application includes a desktop application.

5. The information processing apparatus according to claim 4, wherein the desktop application includes a launcher application.

6. The information processing apparatus according to claim 3, wherein the second application includes a Universal Windows ° Platform application.

7. The information processing apparatus according to claim 1, wherein the first application performs control such that the first window is prevented from being closed during a period in which the first application is starting the second application.

8. The information processing apparatus according to claim 1, wherein the notification indicating that the second window has been displayed includes parameter information to be used for the second application to start the first application through protocol activation.

9. The information processing apparatus according to claim 1, wherein the notification indicating that the second window has been displayed is transmitted to the first application through inter-process communication between the second application and the first application.

10. An information processing apparatus comprising:
a display unit configured to display a plurality of windows in an overlapping manner, the plurality of windows including a first window for a first application, a second window for a second application to be started by the first application, and a third window for a third application to be started by the second application,
wherein the third application transmits, to the first application, a notification indicating that the third window has been displayed, and
wherein the first application performs display control to hide the first window in a case where the notification is received.

11. The information processing apparatus according to claim 1, wherein the first application includes a Universal Windows® Platform application.

12. The information processing apparatus according to claim 11, wherein the first application starts the second application via Desktop Bridge.

13. The information processing apparatus according to claim 12, wherein the second application includes a launcher application.

14. The information processing apparatus according to claim 10, wherein the third application includes a desktop application.

15. A method for controlling an information processing apparatus including a display unit configured to display a plurality of windows in an overlapping manner, the plurality of windows including a first window for a first application and a second window for a second application to be started by the first application, the method comprising:
performing notification by causing the second application to transmit, to the first application, a notification indicating that the second window has been displayed; and
performing display control to cause the first application to hide the first window in a case where the notification is received.
